(19) United States
(12) Patent Application Publication
(10) Pub. No.: US 2006/0228683 A1
(43) Pub. Date: Oct. 12, 2006

(54) Multi-functional karaoke microphone

(75) Inventor: Gao Jianping, Shanghai (CN)

Correspondence Address: Raymond Y. Chan, 108 N. Ynez Ave., #128, Monterey Park, CA, 91754, US

(73) Assignee: Shanghai Multak Technology Development Co., Ltd.

(21) Appl. No.: 11/102,384

(22) Filed: Apr. 8, 2005

(51) Int. Cl. G10H 7/00; G10H 1/36

(52) U.S. Cl. 434/307 A

(57) ABSTRACT

A karaoke microphone includes a data reader including a data decoder adapted for decoding digital compressed data into video data and background music data and a video encoder encoding the video data into a video output, a microphone unit converting human voice into voice data, an audio enhancing arrangement including a voice mixture module electrically communicating with the data reader to receive the background music data therefrom wherein the voice mixture module integrally mixes the background music data with the voice data to form audio output so as to enhance a quality of the audio output, and a transmission unit transmitting the video output and the audio output to the video-audio system in a synchronizing manner.

### BACKGROUND OF THE PRESENT INVENTION

1. Field of Invention

The present invention relates to a microphone, and more particularly to a karaoke microphone which mixes the voice data with the background music data to form an audio output so as to transfer the audio output and the video output to a video-audio system.

2. Description of Related Arts

Karaoke singing has been so popular among people of all age groups simply because not only does it allow people to listen to their favorite songs, it also allows people to sing along the songs without the voice of the original singer, yet with all background accompaniments. It provides ordinary people a chance to show off themselves and sing just like professional singers do, with the music as the background and a microphone to amplify their voice.

Conventional karaoke was brought about by karaoke machines, wherein song data in the form of LD, VCD, DVD and so forth which usually store both audio data and visual data are inputted into the machine, such that the machine plays the song data. External microphones are usually linked to the karaoke machines, such that when a person sings to the microphone, the microphone transmit the voice input to the karaoke machine. The machine in turn, is linked to, say, a television, such that the audio output outputs the voice input and the audio data together and the visual output are broadcasted. Many a times, the machine is linked to a monitor and an amplifier separately.

Due to the fact that the microphone is separated from the karaoke machine, the voice of the singer is simply being sung over the music accompaniment. The balance between the voice and the background accompaniment hence depend upon the loudness of each, conventionally controlled by the person who has control of the karaoke machine. Very often, the volume of the voice of the singer and the background accompaniment are not balanced, such that either the voice of the singer being too loud that the background cannot be heard or the background being too loud that the singer's voice cannot be heard. Under such situations, the singer may enjoy the singing process, the audience, however, may not appreciate what they are listening.

Also, such karaoke machines are usually big, and require electric wire linkage to power, with the microphone and at least one output device. It has a major drawback of being space consuming and complicated to install. Furthermore, due to the fact that it requires a lot of electric wiring, it posts a fire hazard where it is installed, and post dangers to people around the machine.

Because of its size, karaoke machines are hardly portable, thereby confining karaoke singing to places where such machines are installed. Karaoke singing cannot be enjoyed at home since installation of such machine is expensive and space consuming. As a result, when people desire to sing karaoke, they must travel to a place where such machine is provided. Also, karaoke has always been sung at a fixed location, meaning that karaoke cannot be sung while people are traveling, especially on long journeys, where people could easily do with such form of entertainment to make the journey more enjoyable.

As mentioned above, karaoke machines conventionally play songs from storage devices, such as DVD, LD and VCD, which are space consuming devices. And, with each of such devices only stores about 10-30 songs, having a collection of a lot of songs is simply impractical. And when changing from one song to the next, unless the next song so happen is on the same disc, the disc of the previous song must be taken out, and the disc of the next song must be located, such that the next disc could be inserted into the machine. Such act requires a lot of work, from locating the disc and loading it into the machine. And, when looking for a particular song from a huge amount of discs is very frustrating. The enjoyment of karaoke singing is greatly jeopardized.

As a result, a better karaoke system which can make use of more updated technology has to be provided so as to provide people with a more pleasant, convenient, enjoyable karaoke experience.

### SUMMARY OF THE PRESENT INVENTION

A main object of the present invention is to provide a karaoke microphone which mixes the voice data with the background music data to form an audio output so as to transfer the audio output and the video output to a video-audio system.

Another object of the present invention is to provide a karaoke microphone, wherein a pitch of the voice data is adjusted to balance with a pitch of the background music data when the voice data is mixed with the background music data, so as to optimize said quality of the audio output.

Another object of the present invention is to provide a karaoke microphone such that karaoke can be sung whenever there is an amplifier and the microphone is present, such that no conventional bulky, space-consuming karaoke machine is required.

Another object of the present invention is to provide a karaoke microphone that is portable, such that the karaoke microphone can be taken from place to place, such that karaoke singing can be enjoyed whenever there is an speaker and a monitor, such as a video-audio system installed into a vehicle.

Another object of the present invention is to provide a karaoke microphone, wherein an external memory, such as memory card, where digital compressed data is stored is inputted into the data reader in such a manner that the data reader reads the digital compressed data stored in the external memory.

Another object of the present invention is to provide a karaoke microphone, wherein the digital compressed data stored in the external memory is erasable, such that the external memory can store different digital compressed data, according to the desire of the user.

Another object of the present invention is to provide a karaoke microphone, wherein the data reader further comprises a memory means which stores digital compressed data, such that the memory means is built-in with the karaoke microphone.

Another object of the present invention is to provide a karaoke microphone, further comprises a battery compartment provided for receiving an battery, such that power required by the karaoke can be provided by a battery so that no power cord is required to link the karaoke microphone to a power socket, in such a manner that the portability and convenience of the karaoke microphone is enhanced.

Accordingly, in order to accomplish the above objects, the present invention provides a karaoke microphone for a video-audio system, comprising:

a data reader comprising a data decoder adapted for decoding digital compressed data into video data and background music data and a video encoder encoding the video data into a video output;

a microphone unit converting human voice into voice data;

an audio enhancing arrangement comprising a voice mixture module electrically communicating with the data reader to receive the background music data therefrom wherein the voice mixture module integrally mixes the background music data with the voice data to from audio output so as to enhance a quality of the audio output; and

a transmission unit transmitting the video output and the audio output to the video-audio system in a synchronizing manner.

Accordingly, the present invention further provides a karaoke method for transmitting digital compressed data from a karaoke microphone to a video-audio system, comprising the steps of:

(a) decoding the digital compressed data into video data and background music data;

(b) encoding the video data into a video output;

(c) converting human voice into voice data;

(d) integrally mixing the background music data with the voice data to from audio output so as to enhance a quality of the audio output; and

(e) transmitting the video output and the audio output to the video-audio system in a synchronizing manner.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a karaoke microphone for a video-audio system according to a preferred embodiment of the present invention.

FIG. 2 is a block diagram of the karaoke microphone according to the above preferred embodiment of the present invention.

FIG. 3 is a block diagram of the audio enhancing arrangement of the karaoke microphone according to the above preferred embodiment of the present invention.

### DETAILED DESCRIPTION OF THE PREFERRED EMBODIMENT

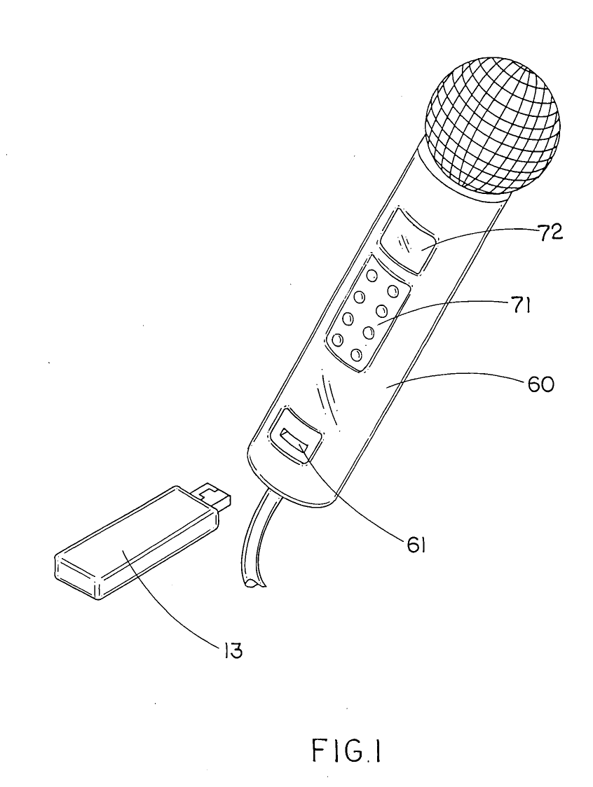

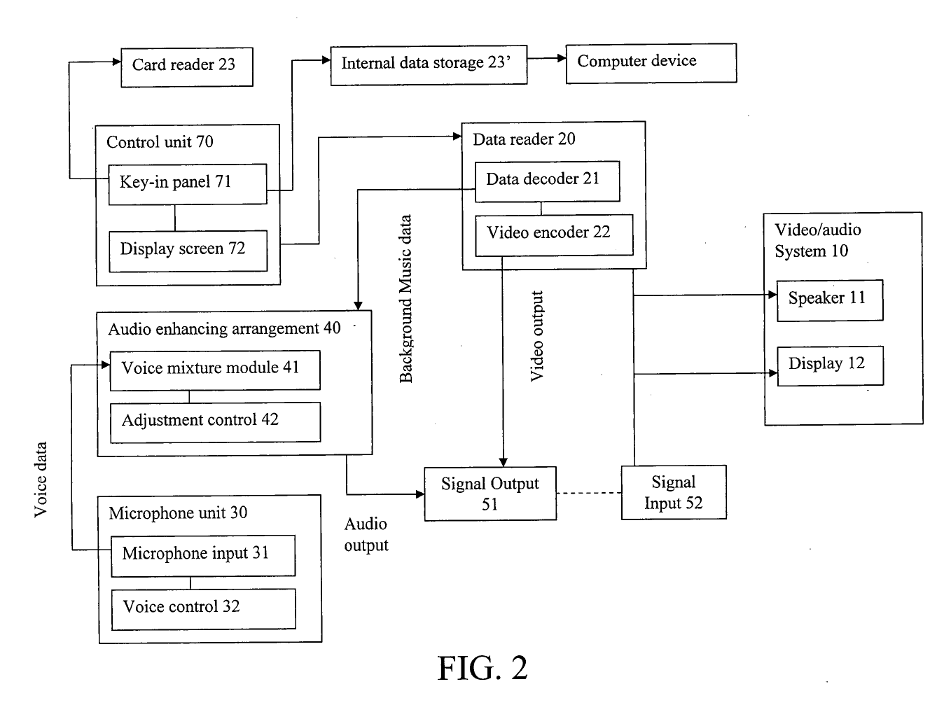

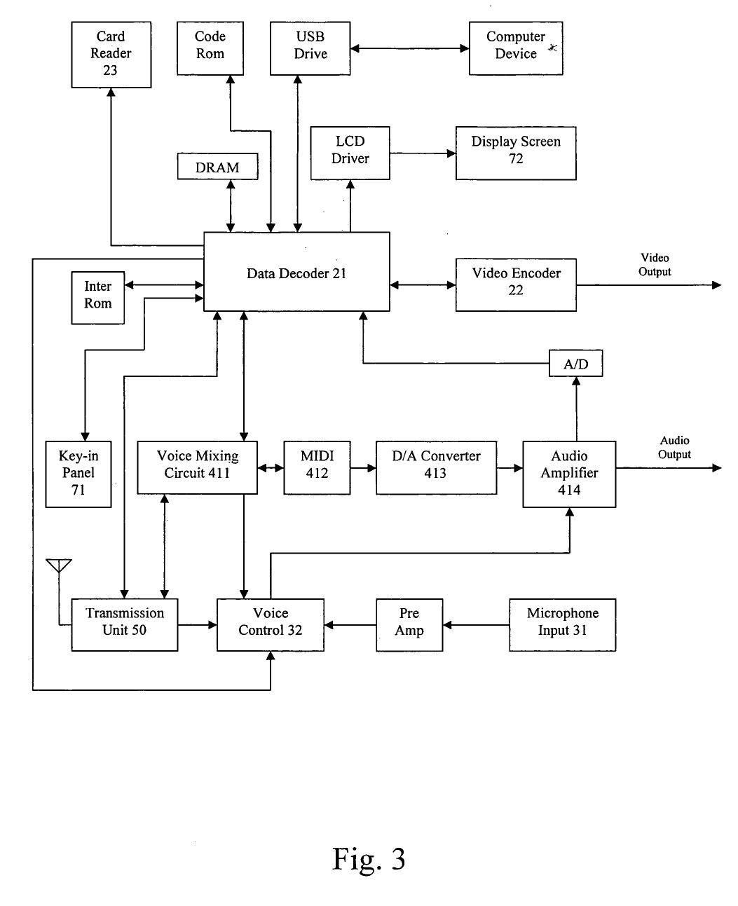

Referring to FIGS. 1 through 3 of the drawings, a karaoke microphone for a video-audio system 10 is illustrated, wherein the video-audio system 10, such as a home theater or an entertainment system for vehicle, comprises a speaker 11 and a display 12.

The karaoke microphone comprises a data reader 20, a microphone unit 30 converting human voice into voice data, an audio enhancing arrangement 40, and a transmission unit 50.

The data reader 20 comprises a data decoder 21 adapted for decoding digital compressed data into video data and background music data and a video encoder 22 encoding the video data into a video output.

The audio enhancing arrangement 40 comprises a voice mixture module 41 electrically communicating with the data reader 20 to receive the background music data therefrom, wherein the voice mixture module 41 integrally mixes the background music data with the voice data to from audio output so as to enhance a quality of the audio output.

The transmission unit 50 is transmitting the video output and the audio output to the video-audio system 10 in a synchronizing manner.

According to the preferred embodiment, the song data is stored and save as the digital compressed data to minimize the size of the song data. The data decoder 21 decodes the digital compressed data into the digital video data and the digital background music data. The video data, which is in form of MPEG1 format, contains video signal and lyrics caption such that when the video data is encoded by the video encoder 22, the video data is converted into the video output that the video signal and the lyrics caption are displayed on the display 12. of the video-audio system 10. It is worth to mention that the video data can be stored and saved in other digital formats, such as MPEG2, for enhancing the video quality of the digital compressed data.

The microphone unit 30 comprises a microphone input 31 for receiving the human voice and a voice control 32 to selectively adjust the human voice. Accordingly, the voice control 32 is arranged to selectively adjust the volume and the echo of the human voice before mixing with the background music data.

As shown in FIGS. 1 through 3, the karaoke microphone further comprises a hand-held housing 60 receiving the data reader 20, the microphone unit 30, the audio enhancing arrangement 40 and the transmission unit 50. Therefore, the user is able to carry the karaoke microphone everywhere to link to different video-audio systems 10.

In order to enhance the portability of the present invention, the karaoke microphone further comprises a power supply P provided in the hand-held housing 60. Accordingly, the power supply P is a rechargeable battery supported in the hand-held housing 60 and is adapted to be re-charged for supplying electrical energy. Alternatively, the power supply P can be a battery compartment provided in the hand-held housing 60 for replaceable batteries receiving therein such that the user is able to replace the new batteries so a to use the karaoke microphone anytime and anywhere.

The data reader 20 further comprises a card reader 23 electrically connected to the data decoder 21 for reading a memory card 13 having the compressed data pre-stored therein, wherein the hand-held housing 60 has a card slot 61 adapted for the memory card 13 detachably sliding therein so as to read the digital compressed data by the card reader 23. In other words, the memory card 13, which is embodied as “Secure Digital card”, “CompactFlash” or “Sony Memory Stick”, functions as an external data storage to transfer the digital compressed data to the karaoke microphone such that the user is able to save and erase the digital compressed data in the memory card 13.

However, according to the preferred embodiment of the present invention, the card reader 23 is a Universal Serial Bus (USB) port and the memory card 13 is a USB memory, such that the USB port is electrically connected to the data decoder 21 for reading the USB memory having the compressed data pre-stored therein. Hence, the card slot 61 on the hand-held housing 60 is a USB memory slot.

An advantage of utilizing USB port and USB memory is that most computers and laptops nowadays are equipped with USB ports, such that songs can be conveniently uploaded from the computer to the USB memory for the card reader 23 to read the data within, without the use of any external card readers to link the memory card to the computer. As a result, the use of USB memory and USB port allows a user to easily access the music in the computer, choose the songs from the computer and sing it with the karaoke microphone.

Alternatively, an internal data storage 23′ is built-in the karaoke microphone to electrically connect to the data decoder 21 for pre-storing the compressed data wherein the internal data storage 23′ has a computer port adapted for communicatively linking to a computer device so as to transfer the digital compressed data from the computer device to the internal data storage 23′.

The voice mixture module 41 comprises a voice mixing circuit 411 arranged to integrally mix the background music data with the voice data to from audio output so as to enhance a quality of the audio output. The voice mixture module 41 further comprises a musical instrument digital interface (MIDI) 412 and a digital-to-analogue converter 413 for modification of the audio output. The digital-to-analogue converter 413 facilitates the conversion of the voice data from digital form to analogue form. An advantage of the use of digital-to-analogue converter 413 is that when the sign voice data is in analogue form, it can be recorded.

It is worth to mention that the voice data from the microphone unit 30 is preferably converted into digital form before the voice data is mixed with the background music data through the voice mixture module 41. Preferably, an audio amplifier 414 is connected to the voice mixing circuit 411 for amplifying the audio output before transmitting to the video-audio system 10.

It is worth to mention that the conventional microphone transmits the video output, the background music data and the voice data individually to the video-audio system 10 such that no mixing process between the background music data and the voice data is performed to enhance the quality of the audio output.

The audio enhancing arrangement 30 further comprises an adjustment control 42 self-adjusting a pitch of said voice data to balance with a pitch of said background music data so as to optimize said quality of said audio output. For example, when the volume of the voice data is relatively lower than that of the background music data, the adjustment control 42 automatically increase the volume of the voice data to match with the background music data so as to prevent the background music data overriding with the voice data.

The karaoke microphone further comprises a control unit 70 comprising a key-in panel 71 electrically connected to the data reader 20 for selectively activating the digital compressed data to be decoded by the data decoder 21, and a display screen 72 provided on the hand-held housing 60 for displaying data, such as the song number, such that the user is able to select the desired compressed data to be decoded through the key-in panel 71 so as to conveniently choose the song to be sung.

The display screen 72 can also display the digital compressed data to be processed. In other words, not only is the user able to select the desired compressed data to be decoded through the key-in panel 71, he/she can also check the corresponding compressed data through the display screen 72 such as an LCD display.

The transmission unit 50 comprises a signal output 51 adapted to send the video data and the audio output, and a signal input 52 communicating with the signal output 51 such that the signal input 52 is adapted for electrically connecting to the video-audio system 10 to form a communication link to transfer the video output and the audio output to the video-audio system 10. In other words, the video output is transmitted to the display 12 of the video-audio system 10 while the audio output is transmitted to the speaker 11 of the video-audio system 10.

In addition, the transmission unit 50 can perform wirelessly when the signal output 51 is a radio frequency signal transmitter adapted to send the video data and the audio output in form of radio frequency, and the signal input 52 is a radio frequency signal receiver wirelessly communicating with the radio frequency signal transmitter such that the radio frequency signal receiver is adapted for electrically connecting to the video-audio system 10 to form a wireless communication link to transfer the video output and the audio output to the video-audio system 10, such that the video output is wirelessly transmitted to the display 12 of the video-audio system 10 while the audio output is wirelessly transmitted to the speaker 11 of the video-audio system 10.

It is worth to mention that the video output and the audio output can be in form of Infrared signal and wirelessly transmitted to the video-audio system 10 through the infrared transmitter and the infrared receiver. Alternatively, a video/audio cable can be used to communicatively link between the karaoke microphone and the video-audio system 10 so as to transmit the video output and the audio output to the video-audio system 10 through the video/audio cable. Therefore, the karaoke microphone of the present invention can be taken from place to place, such that karaoke singing can be enjoyed whenever there is an speaker and a monitor, even in the vehicle having the video-audio system 10.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A karaoke microphone for a video-audio system, comprising:
a data reader comprising a data decoder adapted for decoding digital compressed data into video data and background music data and a video encoder encoding said video data into a video output;
a microphone unit converting human voice into voice data;
an audio enhancing arrangement comprising a voice mixture module electrically communicating with said data reader to receive said background music data therefrom, wherein said voice mixture module integrally mixes said background music data with said voice data to from audio output so as to enhance a quality of said audio output;
a transmission unit transmitting said video output and said audio output to said video-audio system in a synchronizing manner.

2. The karaoke microphone, as recited in claim 1, wherein said audio enhancing arrangement further comprises an adjustment control self-adjusting a pitch of said voice data to balance with a pitch of said background music data so as to optimize said quality of said audio output.

3. The karaoke microphone, as recited in claim 1, further comprising a hand-held housing receiving said data reader, said microphone unit, said audio enhancing arrangement and said transmission unit, wherein said data reader further comprises a card reader electrically connected to said data decoder for reading a memory card having said compressed data pre-stored therein, wherein said hand-held housing has a card slot adapted for said memory card detachably sliding therein so as to read said digital compressed data by said card reader.

4. The karaoke microphone, as recited in claim 2, further comprising a hand-held housing receiving said data reader, said microphone unit, said audio enhancing arrangement and said transmission unit, wherein said data reader further comprises a card reader electrically connected to said data decoder for reading a memory card having said compressed data pre-stored therein, wherein said hand-held housing has a card slot adapted for said memory card detachably sliding therein so as to read said digital compressed data by said card reader.

5. The karaoke microphone, as recited in claim 1, wherein said data reader further comprises an internal data storage electrically connected to said data decoder for pre-storing said compressed data, wherein said internal data storage has a computer port adapted for communicatively linking to a computer device so as to transfer said digital compressed data from said computer device to said internal data storage.

6. The karaoke microphone, as recited in claim 2, wherein said data reader further comprises an internal data storage electrically connected to said data decoder for pre-storing said compressed data wherein said internal data storage has a computer port adapted for communicatively linking to a computer device so as to transfer said digital compressed data from said computer device to said internal data storage.

7. The karaoke microphone, as recited in claim 4, further comprising a control unit comprising a key-in panel electrically connected to said data reader for selectively activating said digital compressed data to be decoded by said data decoder, and a display screen provided on said hand-held housing for displaying said digital compressed data to be processed.

8. The karaoke microphone, as recited in claim 6, further comprising a control unit comprising a key-in panel electrically connected to said data reader for selectively activating said digital compressed data to be decoded by said data decoder, and a display screen provided on said hand-held housing for displaying said digital compressed data to be processed.

9. The karaoke microphone, as recited in claim 3, wherein said card reader is a universal serial bus (USB) port and said memory card is a USB memory.

10. The karaoke microphone, as recited in claim 4, wherein said card reader is a universal serial bus (USB) port and said memory card is a USB memory.

11. The karaoke microphone, as recited in claim 7, wherein said card reader is a universal serial bus (USB) port and said memory card is a USB memory

12. A karaoke method for transmitting digital compressed data from a karaoke microphone to a video-audio system, comprising the steps of:
(a) decoding said digital compressed data into video data and background music data;
(b) encoding said video data into a video output;
(c) converting human voice into voice data;
(d) integrally mixing said background music data with said voice data to from audio output so as to enhance a quality of said audio output; and
(e) transmitting said video output and said audio output to said video-audio system in a synchronizing manner.

13. The method as recited in claim 12, in step (d), further comprising a step of adjusting a pitch of said voice data to balance with a pitch of said background music data so as to optimize said quality of said audio output.

14. The method as recited in claim 12, in step (a), further comprising a step of reading said digital compressed data pre-stored in a memory card.

15. The method as recited in claim 13, in step (a), further comprising a step of reading said digital compressed data pre-stored in a memory card.

16. The method, as recited in claim 12, in step (a), further comprising a step of reading said digital compressed data pre-stored in a USB memory.

17. The method, as recited in claim 13, in step (a), further comprising a step of reading said digital compressed data pre-stored in a USB memory.
